(19) United States
(12) Patent Application Publication
(10) Pub. No.: US 2001/0043801 A1
(43) Pub. Date: Nov. 22, 2001

(54) DATA RECORDING AND/OR REPRODUCING APPARATUS AND METHOD

(76) Inventor: SHINICHI KOMORI, KANAGAWA (JP)

Correspondence Address: Bell Boyd & Lloyd LLC, P O Box 1135, Chicago, IL, 60690-1135, US

(21) Appl. No.: 09/130,618

(22) Filed: Aug. 7, 1998

(30) Foreign Application Priority Data
Aug. 8, 1997 (JP) P09-214985

(51) Int. Cl. H04N 5/76; H04N 5/225; H04N 5/781

(52) U.S. Cl. 386/117; 386/125; 348/207

(57) ABSTRACT

A data recording and/or reproducing apparatus and method for the system scale is arranged to capable of being expanded. The present invention causes distribution means to separate first video data into a plurality of second video data in predetermined frames, and cyclically distribute said video data to a plurality of systems, each recording and/or reproducing means to record the second video data of the corresponding system of provided through the network to each recording and/or reproducing means, output means to provide a reproduction request for corresponding second video data to each recording and/or reproducing means through the network in response to a reproduction request for the first video data, and each recording and/or reproducing means to reproduce and output the first video data based on the second video data reproduced from the recording medium and provided through the network, whereby it is possible to attain a data recording and/or reproducing method which can distribute the recording or reproduction processing of the second video and/or audio data to each system to reduce processing load on one recording and/or reproducing means, and thus to accommodate more recording and reproduction requests by that amount, so that it is possible to attain a data recording and/or reproducing apparatus and method in which the system scale can be expanded.

### BACKGROUND OF THE INVENTION

1. Field of the Invention

The present invention relates to a data recording and/or reproducing apparatus and method, and is advantageously applied to, for example, a client server system.

2. Description of the Related Art

Conventionally, a client server system is configured by attaching one hard disk drive to one server computer, which is connected to a plurality of client computers through a network.

In this case, in a recording mode, the client server system supplies, for example, video and/or audio data reproduced from a video tape by a video tape recorder to the server computer through any one of the client computers. Then, the server computer records the supplied video and/or audio data in a hard disk in said hard disk drive.

In addition, in the client server system in a reproduction mode, any one of the client computers provides a reproduction request to the server computer in response to an operation by an operator. Said server computer reproduces the specified video and/or audio data from a hard disk in the hard disk drive, and sends out said data to the client computer.

In this way, the client server system is arranged in such a way that any client computer can request recording and reproduction of video and/or audio data to the server computer.

Recently, the client server system having such a configuration is more and more demanded to increase the number of client computers to expand the system scale, thereby such large number of client computers being able to request recording or reproduction to the server computer.

However, when the client server system is configured as described above, there is a possibility that requests for recording or reproduction are concentrated at almost the same time from a plurality of client computers to the server computer. In this case, requests for recording processing or reproduction processing exceed the recording or reproduction processing capacity of the server computer and the hard disk drive, whereby it becomes difficult to handle a recording or reproduction request from each client computer. Therefore, it is difficult to increase easily the number of client computers in such a client server system, so that there is a problem that the system scale is difficult to be expanded easily.

One approaching to solve such problems is increasing the number of server computers attached with a hard disk drive, as well as the number of client computers. Each of these server computers is arranged to store same video and/or audio data in a hard disk within the corresponding hard disk drive so as to distribute reproduction requests for the same video and/or audio data from a plurality of client computers to each server computer.

However, while this approach can significantly increase the storage capacity of the entire system according to the number of hard disk drives, there is a problem that the utilization efficiency of each hard disk drive is significantly low. Because the hard disk in each of hard disk drives stores the same video and/or audio data.

### SUMMARY OF THE INVENTION

In view of the foregoing, an object of this invention is to provide a data recording and/or reproducing apparatus and method for which the apparatus scale can be increased by allowing it to easily increase distribution means and output means.

To solve such a problem, the present invention comprises distribution means for separating first supplied video data into a plurality of second video data in predetermined frames, and cyclically distributing said data to a plurality of systems, a plurality of recording and/or reproducing means each connected to the distribution means through a network and correspondingly provided for each system, and for recording or reproducing the second video data of corresponding system provided through the network to or from a recording medium, and output means connected to each recording and/or reproducing means through the network, and for providing a reproduction request for corresponding second video data to each recording and/or reproducing means through the network in response to a reproduction request for the first video data, and reproducing and outputting the first video data based on the second video data reproduced from the recording medium by each recording and/or reproducing means and provided through the network.

Consequently, the recording or reproduction processing of the second video/sound data can be distributed to each of recording and/or reproducing means to reduce the processing load on one recording and/or reproducing means, so that more recording and reproduction requests can be accommodated by that amount.

The present invention also comprises a first step of separating first supplied video data into a plurality of second video data in predetermined frames, and cyclically distributing said video data to a plurality of systems, a second step of recording the second video data provided through the network from each system to a recording medium for each system, and a third step of providing a reproduction request for corresponding second video data to each recording medium through the network in response to a reproduction request for the first video data, and reproducing and outputting the first video data based on the second video data reproduced from the recording medium and provided through the network.

Consequently, the recording or reproduction processing of the second video/sound data can be distributed to each system to reduce the processing load on one system, so that more recording and reproduction requests can be accommodated by that amount.

The nature, principle and utility of the invention will become more apparent from the following detailed description when read in conjunction with the accompanying drawings in which like parts are designated by like reference numerals or characters.

### BRIEF DESCRIPTION OF THE DRAWINGS

In the accompanying drawings:

FIG. 1 is a schematic block diagram for illustrating recording and reproduction of video and/or audio data by a client server system;

FIG. 2 is a schematic block diagram for illustrating recording and reproduction of video and/or audio data by a client server system;

FIG. 3 is a schematic view for illustrating index information data recorded in a hard disk in a hard disk drive; and

FIG. 4 is a block diagram showing a configuration of a client server system according to another embodiment.

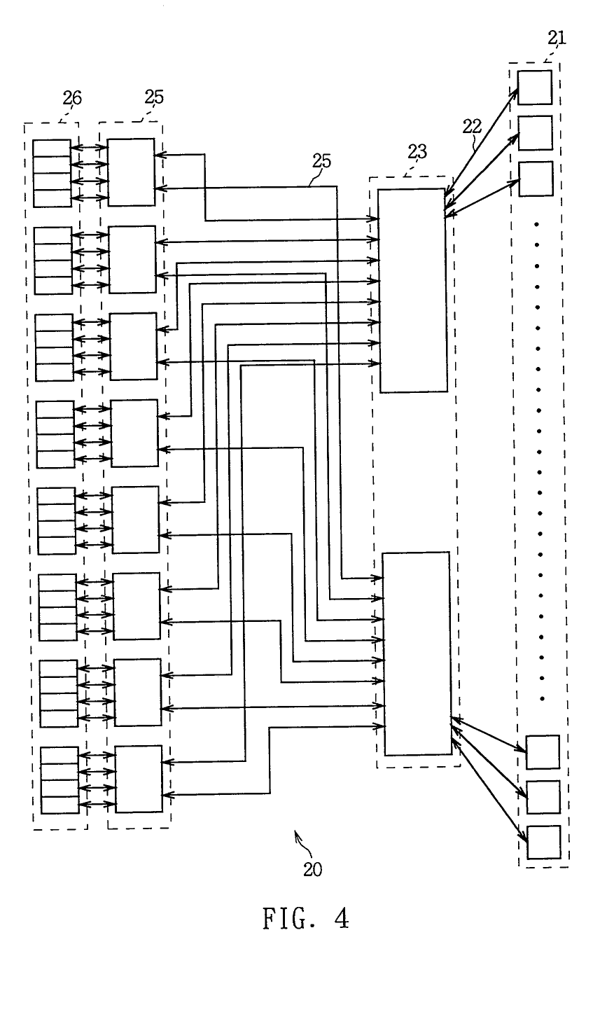

### DETAILED DESCRIPTION OF THE EMBODIMENT

Preferred embodiments of this invention will be described with reference to the accompanying drawings:

(1) Configuration of Client server System According to An Embodiment

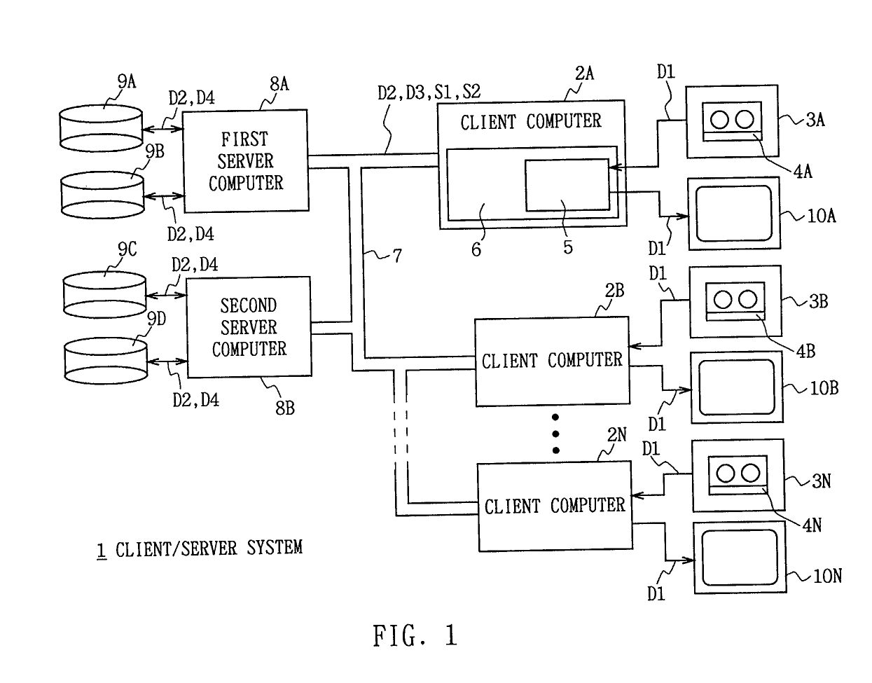

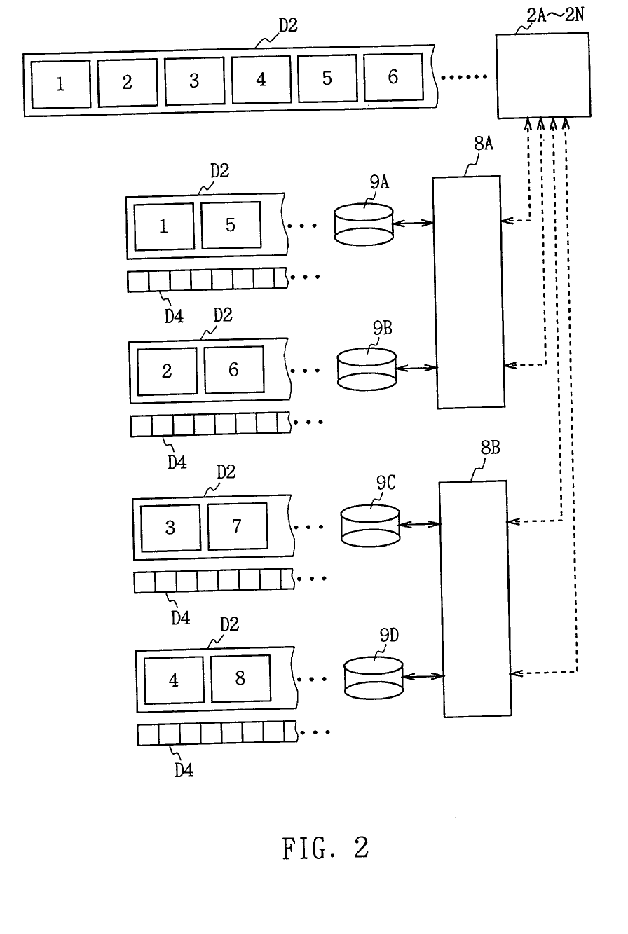

Referring to FIGS. 1 and 2, 1 generally denotes a client server system to which the present invention is applied, and in which, in a recording mode, video and/or audio data D1 reproduced from video tapes 4A-4N by any one of video tape recorders 3A-3N which are respectively connected to a plurality of client computers 2A-2N, is supplied to a corresponding client computer 2A-2N.

Each of client computers 2A-2N is provided with a video input/output port 6 having a frame memory 5 therein. Said client computers 2A-2N successively takes in the video and/or audio data D1 supplied from the video tape recorder 3A-3N via the frame memory 5 by the frame, and successively compresses and encodes the taken-in video and/or audio data D1 by the frame with the motion JPEG system (Joint Photographic coding Experts Group system) for example, in order to generate compressed and encoded data D2.

In addition, each of client computers 2A-2N generates additional information data D3 consisting of frame number information indicating from which frame counted from the top of the video and/or audio data D1, the compressed and encoded data D2 is generated, and information on the compressed and encoded data D2 (hereinafter called “size information”).

Then, each of client computers 2A-2N cyclically distributes the generated compressed and encoded data D2 by two frames together with the corresponding additional information data D3 to the first and second server computers 8A and 8B connected through an FDDI (Fiber Distributed Data Interface) network ring 7.

The first and second server computers 8A and 8B are respectively attached with two hard disk drives 9A-9D, and cyclically distribute the compressed and encoded data D2 to said four hard disk drives 9A-9D by the frame.

Practically, every time the first server computer 8A is provided with the compressed and encoded data D2 for two frames via said client computers 2A-2N, it files the top one frame of compressed and encoded data D2 (that is, said data D2 indicating the frame number; the first, fifth, ninth, or the like), and records said data D2 in the first recording region of a hard disk in a hard disk drive 9A. In the same way, said first server computer 8A files the compressed and encoded data D2 for the following one frame (that is, said data D2 indicating the frame number; the second, sixth, tenth or the like), and records said data D2 in the first recording region of a hard disk in the other hard disk drive 9B.

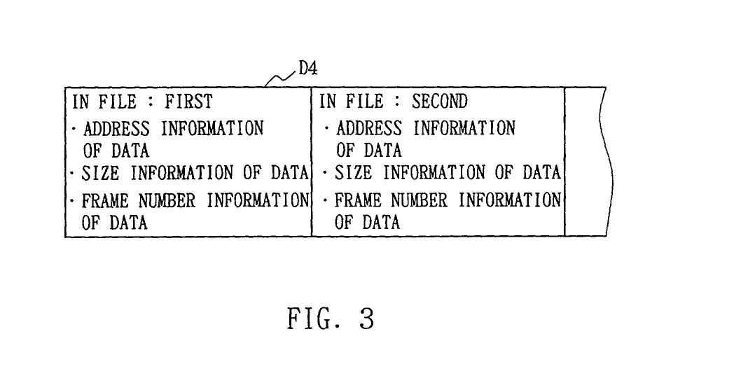

In addition, the first server computer 8A appends address information of corresponding compressed and encoded data D2 to the additional information data D3 supplied from the client computer 2A-2N, in order to generate index information data D4. Further, said server computer 8A files and records said information data D4 in a second recording area of a hard disk in the hard disk drive 9A or 9B, in which corresponding compressed and encoded data D2 is recorded. Incidentally, as shown in FIG. 3, the index information data D4 indicates address information, size information and frame number information of the n-th corresponding compressed and encoded data D2 recorded in each hard disk drive 9A-9D.

The first server computer 8A creates a file management table, in which the file name of the compressed and encoded data D2 recorded in a hard disk in each of the hard disk drives 9A and 9B is respectively corresponded to that of the index information data D4. Then, said information table is stored in a memory provided in said first server computer BA.

In the same way, every time the second server computer 8B is provided with the compressed and encoded data D2 for two frames via said client computers 2A-2N, it files the top one frame of the compressed and encoded data D2 (said data D2 indicating the frame number; third, seventh, eleventh, or the like), and records said data D2 in the first recording area of the hard disk in one hard disk drive 9C. In the same way, said second server computer files the following compressed and encoded data D2 for one frame (said data D2 indicating frame number; fourth, eighth, twelfth or the like), and records said data D2 in the second recording area of the hard disk in the other hard disk drive 9D.

In addition, the second server computer 8B appends address information of corresponding compressed and encoded data D2 to the additional information D3 supplied from the client computer 2A-2N in order to generate index information data D4. Further, said second server computer 8B files and records said index information data D4 in a second recording area of hard disks in the hard disk drives 9C and 9D, in which corresponding compressed and encoded data D2 is stored. Said server computer 8B creates a file management table, in which the file name of the compressed and encoded data D2 recorded in said hard disks in each of the hard disk drives 9C and 9D is corresponded to that of the index information data D4. Said index information data D4 is stored in a memory provided said server computer 8B.

Then, the compressed and encoded data D2 recorded in each hard disk drive 9A-9D can be reproduced with each of client computers 2A-2N.

Practically, when the client computers 2A-2N are selected the reproduction mode for the video and/or audio data D1 by an operator, said client computers 2A-2N provide mode change-over request indicating the reproduction mode to the first and second server computers 8A and 8B. At the same time, said client computers 2A-2N generate reproduction request signals S1 indicating respectively a plurality of predetermined frame numbers (for example, the first, thirty-first, sixty-first, or the like). Then, said reproduction signals S1 are sent out to the first or second server computer 8A or 8B, to which the compressed and encoded data D2 having the same frame numbers as those of said signals Si is distributed.

In this case, the first and second server computers 8A and 8B proceed to the reproduction mode in compliance with the mode change-over request provided by the client computer 2A-2N. Then, said server computers 8A and 8B retrieve the file name of the corresponding index information data D4 from the file management table based on the reproduction request provided by said client computers 2A-2N. Further, said server computers 8A and 8B reproduce the index information data D4 of the obtained file name from a hard disk in the corresponding hard disk drives 9A-9D, and reproduce the corresponding compressed and encoded data D2 from a hard disk in each hard disk drive 9A-9D recorded therein, based on the address information and size information indicated by said reproduced index information data D4, and send said reproduced data D2 out to the client computers 2A-2N.

Consequently, the client computers 2A-2N decode the compressed and encoded data D2 supplied from the first and second server computers 8A and 8B, and successively send the obtained video and/or audio data D1 out to the monitors 10A-10N through the frame memory 5, so that an video (a still video) based on a plurality of video and/or audio data D1 for one frame are displayed on the monitors 10A-10N en bloc.

Then, the client computers 2A-2N are arranged to be capable of specifying an desired video among said videos displayed on the monitors 10A-10N by an operator with using a mouse or the like. When the operator specifies an video, from which the video and/or audio data D1 is started reproducing (hereinafter called a “reproduction starting video), and an video, at which reproduction of the video and/or audio data D1 is ended (hereinafter called an “reproduction ending video”), the client computers 2A-2N generate a reproduction request signal S2 indicating all frame numbers respectively from a frame number of the video and/or audio data D1 based on the specified reproduction starting video to the reproduction ending video. Said client computers 2A-2N cyclically distribute said reproduction request signal S2 respectively to the corresponding first and second server computers 8A and 8B.

Thus, every time when first and second server computers 8A and 8B are provided the reproduction request signal S2 from each of client computers 2A-2N, said server computers 8A and 8B retrieve a file name of the corresponding index information data D4 from the file management table based on the reproduction request signal S2, and reproduce the index information data D4 of the obtained file name from the hard disk in the corresponding hard disk drives 9A-9D.

Then, the first and second server computers 8A and 8B cyclically reproduces the compressed and encoded data D2 for one frame from four hard disk drives 9A-9D based on the address information and size information indicated by the reproduced and obtained index information data D4. At the same time, said server computers 8A and 8B send the compressed and encoded data D2 obtained by reproducing out to the client computers 2A-2N in order to restore said data D2 to the original continuous compressed and encoded data D2 on the FDDI network ring 7.

Thus, the client computers 2A-2N decode the compressed and encoded data D2 successively supplied from the first and second server computers 8A and 8B, and restore successively the original video and/or audio data D1 from the obtained video and/or audio data D1 through the frame memory 5. Then, said data D1 is sent out to the monitors 10A-10N, thereby videos (videos from the reproduction starting to the reproduction ending) based on the video and/or audio data D1 being capable of displaying on the monitors 10A-10N.

Furthermore, in this client server system 1, when the first server computer 8A files the compressed and encoded data D2 and the index information data D4, for example, the compressed and encoded data D2 is saved under a file name “file A-1.dat” with an extension of “dat”, and the index information data D4 is saved under a file name “file A-1.idx” with an extension of “idx,” in the hard disk drive 9A. In the same way, in the hard disk drive 9B the compressed and encoded data D2 is saved under a file name “file A-2.dat” and the index information data D4 is saved under a file name of “file A-2.idx.”

Then, the second server computer 8B saves, for example, in the hard disk drive 9C, the compressed and encoded data D2 is saved under a file name “file A-3.dat” and the index information data D4 is saved under a file name “file A-3.idx,”. In the same way, in the hard disk drive 9D, the compressed and encoded data D2 is saved under a file name “file A-4.dat” and the index information data D4 is saved under a file name “file A-4.idx.” Note that, numerals (1-4) in the file names should correspond to frame numbers.

In this client server system 1, the head portion of file names are uniform, so that the client computer 2A-2N can be transferred to the reproduction mode by an operator inputting only the common part of file names, for example, “file A” through a keyboard. And at the same time, the reproduction request S1 can be provided to the first and second server computers 8A and 8B by the same operation. That is, the operation by an operator can be simplified.

(2) Operation and Advantages According to the Embodiment

In the above-described arrangement of the client server system 1, every time when the client computers 2A-2N cyclically distributes the compressed and encoded data D2 by two frames to the first and second server computers 8A and 8B in recording mode, said first and second server computers 8A and 8B cyclically distribute the compressed and encoded data D2 by one frame to four hard disk drives 9A-9D, and record said data D2 in a hard disk in each of hard disk drives 9A-9D.

In addition, in the client server system 1, every time when the client computers 2A-2N cyclically provide, in the reproduction mode, a reproduction request to the first and second server computers 8A and 8B, said first and second server computers 8A and 8B reproduce the compressed and encoded data D2 by one frame from four hard disk drives 9A-9D, and send the compressed and encoded data D2 obtained by the reproduction, out to the client computers 2A-2N through the FDDI network ring 7.

Therefore, in this client server system 1, the first and second server computers 8A and 8B perform the recording or reproduction processing only on the compressed and encoded data D2 for two frames by every compressed and encoded data D2 for four frames. Each of hard disk drives 9A-9D performs the recording or reproduction processing only on the compressed and encoded data D2 for one frame of every compressed and encoded data D2 for four frames. Therefore, in this invention, recording and reproduction processing load of each said first and second server computers 8A and 8B can be reduced to approximately a half in the conventional client server systems. Further, recording and reproduction processing load of each of the hard disk drives 9A-9N can be reduced to approximately one fourth compared to the conventional systems.

Thus, in the client server system 1 compared with the conventional client server systems, the first and second server computers 8A and 8B can accommodate with more recording or reproduction requests, due to the reduction of processing load on the first and second server computers 8A and 8B, as well as on each of hard disk drives 9A-9D.

In addition, as the client server system 1 reduces the processing load on the first and second server computers 8A and 8B, as well as on each of hard disk drives 9A-9D, each of hard disk drives 9A-9D can record multiple types of video and/or audio data. Therefore, utilization efficiency can be significantly improved for each of hard disk drives 9A-9D.

According to the above-described arrangement, every time when the client computers 2A-2N cyclically distribute the compressed and encoded data D2 by two frames to the first and second server computers 8A and 8B through the FDDI network ring 7, said first and second server computers 8A and 8B cyclically distribute and record the compressed and encoded data D2 for one frame to each of four hard disk drives 9A-9D. At the same time, every time when the client computer 2A-2N provides a reproduction request to the first and second server computers 8A and 8B, these two server computers 8A and 8B cyclically and subsequently reproduce the compressed and encoded data D2 from said four hard disk drives 9A-9D, and send said data D2 out to the client computers 2A-2N through the FDDI network ring 7. Thus, as the recording or reproduction processing on the compressed and encoded data D2 can be dispersively distributed to the first and second server computers 8A and 8B, and each hard disk drives 9A-9D, the processing load on each of the first and second server computes 8A and 8B as well as on each of the hard disk drives 9A-9D is reduced. Thus, Said first and second computers can handle more recording or reproduction requests provided for the first and second server computers 8A and 8B from more client computers 2A-2N due to the reduction of the processing load, so that the system scale can be significantly expanded by easily increasing the number of client computers 2A-2N.

(3) Other Embodiments

So far, the above embodiment is described in case of the recording mode. That is, the video and/or audio data D1 reproduced from the video tape by the video tape recorders 3A-3N is provided for an applicable client computers 2A-2N. However, the present invention is not limited to such an arrangement, but can provide video and/or audio data externally provided through a line or the like for the client computers 2A-2N.

In addition, the above embodiment is described for a case where compressed and encoded data D2 which is obtained by compressing and encoding the video and/or audio data D1, is recorded in each of hard disk drives 9A-9D. However, the present invention is not limited to such an arrangement, but can separate the video and/or audio data D1 or the compressed and encoded data D2 into each frame, and record it in predetermined number of frames in each of hard disk drives 9A-9D.

Furthermore, the above embodiment is described for a case where the hard disk drive 9A-9D is used for recording the compressed and encoded data D2. However, the present invention is not limited to such an arrangement, but can be used various other recording and/or reproducing devices such as a recording and/or reproducing device having a disk-shaped recording medium or a so-called disk array device having a plurality of hard disk drives.

Furthermore, the above embodiment is described for a case where two hard disk drives 9A-9D are respectively connected to the first and second server computers 8A and 8B. However, the present invention is not limited to such an arrangement, but can connect each one hard disk drive to the first and second server computers 8A and 8B. Even in this case, processing load on the first and second server computers can be reduced to approximately a half of that in case that only one server computer is provided. Thus, the same advantages as the above embodiment can be attained.

In addition, for example, the client server system 20 may be arranged in such a way that the client computer 21 cyclically distributes video and/or audio data, for four frames, for example, to eight server computers 25 successively through an FDDI network ring 22, a network switch 23, and an FDDI network ring 24. Each server computer 25 distributes and records the video and/or audio data for four frames supplied from the client computer 21 by one frame after another to four recording and/or reproducing devices 26 such as hard disk drives. Processing load in the recording or reproduction processing can be further reduced by increasing further the number of the server computers 25 and the recording and/or reproducing devices 26 as just described, so that the number of client computers can be further increased in order to expand the system scale.

Furthermore, the above embodiment is described for a case where the client computer 2A-2N is applied as means for separating the supplied first video and/or audio data D1 into a plurality of second video and/or audio data D2 by frames, and cyclically distributing them to a plurality of systems. However, the present invention is not limited to such an arrangement, but can be applied to various other distribution means.

Furthermore, the above embodiment is described for a case where the first and second server computers 8A and 8B, as well as the hard disk drives 9A-9D are applied as a plurality of recording and/or reproducing means connected to respective distribution means 2A-2N through the network 7, provided in correspondence to each system, and recording or reproducing the second video data D2 in the corresponding system provided from the distribution means 2A-2N through the network 7 in or from the recording medium. However, the present invention is not limited to such an arrangement, but can be applied to various other recording means.

Furthermore, the above embodiment is described for a case where the client computers 2A-2N are applied as output means connected to each of the recording and/or reproducing means 8A and 8B, as well as 9A-9N through the network 7, providing a reproduction request S2 for the second video data D2 corresponding to each of the recording and/or reproducing means 8A and 8B, as well as 9A-9D to each of the recording and/or reproducing means 8A and 8B, as well as 9A-9D through the network 7 in response to a reproduction request for the first video data D1, and restoring and outputting the first video data D1 based on the second video data D2 reproduced from the recording medium by each of the recording and/or reproducing means 8A and 8B, as well as 9A-9D and provided through the network 7. However, the present invention is not limited to such an arrangement, but can be applied to various other distribution means.

As described above, the present invention comprises distribution means for separating first supplied video data into a plurality of second video data in predetermined frames, and cyclically distributing them to a plurality of systems, a plurality of recording and/or reproducing means each connected to the distribution means through a network and correspondingly provided for each system, and for recording or reproducing the second video data of corresponding system provided through the network to or from a recording medium, and output means connected to each recording and/or reproducing means through the network, and for providing a reproduction request for corresponding second video data to each recording and/or reproducing means through the network in response to a reproduction request for the first video data, and reproducing and outputting the first video data based on the second video data reproduced from the recording medium by each recording and/or reproducing means and provided through the network, whereby it is possible to attain a data recording and/or reproducing apparatus which can distribute the recording or reproduction processing of the second video and/or audio data to each recording and/or reproducing means to reduce processing load on one recording and/or reproducing means, and thus to accommodate more recording and reproduction requests by that amount, so that the system scale can be expanded by easily increasing the distribution means and the output means.

In addition, the present invention also comprises a first step of separating first supplied video data into a plurality of second video data in predetermined frames, and cyclically distributing them to a plurality of systems, a second step of recording the second video data provided through the network from each system to a recording medium for each system, and a third step of providing a reproduction request for corresponding second video data to each recording medium through the network in response to a reproduction request for the first video data, and reproducing and outputting the first video data based on the second video data reproduced from the recording medium and provided through the network, whereby it is possible to attain a data recording and/or reproducing method which can distribute the recording or reproduction processing of the second video and/or audio data to each system to reduce processing load on one system, and thus to accommodate more recording and reproduction requests by that amount, so that the system scale can be expanded.

While there has been described in connection with the preferred embodiments of the invention, it will be obvious to those skilled in the art that various changes and modifications may be aimed, therefore, to cover in the appended claims all such changes and modifications as fall within the true spirit and scope of the invention.

What is claimed is:

1. A data recording and/or reproducing apparatus comprising:
distribution means for separating first supplied video data into a plurality of second video data in predetermined frames, and cyclically distributing said video data to a plurality of systems;
a plurality of recording and/or reproducing means each connected to said distribution means through a network and correspondingly provided for each of said systems, for recording and reproducing said second video data of corresponding system provided through said network on and from a recording medium; and
output means connected to each recording and/or reproducing means through said network, and for providing a reproduction request for corresponding second video data to each recording and/or reproducing means through said network in response to a reproduction request for said first video data, and reproducing and outputting said first video data based on said second video data reproduced from said recording medium by each recording and/or reproducing means and provided through said network.

2. The data recording and/or reproducing apparatus according to claim 1, wherein
said recording and/or reproducing means distributes and records said second video data of said corresponding system provided from said distribution means through said network to and in a plurality of said recording media by predetermined number of frames, and reproduces said second recorded video data from each of said recording media based on said reproduction request for said second video data provided from said output means through said network by said predetermined number of frames according to the order of recording.

3. A data recording and/or reproducing means comprising:
a first step of separating first supplied video data into a plurality of second video data in predetermined frames, and cyclically distributing said video data to a plurality of systems;
a second step of recording said second video data provided through said network from said system to a recording medium for each system; and
a third step of providing a reproduction request for corresponding second video data to each recording medium through said network in response to a reproduction request for said first video data, and reproducing and outputting said first video data based on said second video data reproduced from said recording medium and provided through said network.

4. The data recording and/or reproducing method according to claim 3, wherein
said second step distributes and records said second video data of said corresponding system provided from said system through said network to and in a plurality of said recording media for each of said systems by predetermined number of frames, and
said third step reproduces said second recorded video data from each of said recording media based on said reproduction request for said second video data by said predetermined number of frames according to the order of recording.
